(19) United States
(12) Patent Application Publication
(10) Pub. No.: US 2004/0010686 A1
(43) Pub. Date: Jan. 15, 2004

(54) Apparatus for remote working

(76) Inventors: Cheh Goh, Singapore (SG); Marco Casassa Mont, Bristol (GB)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/418,301

(22) Filed: Apr. 18, 2003

(30) Foreign Application Priority Data
Apr. 18, 2002 (GB) 0208838.3

(51) Int. Cl. H04L 9/00

(52) U.S. Cl. 713/168; 713/171

(57) ABSTRACT

A computer system comprises a computer apparatus that requests a first computer arrangement to provide data to a second computer arrangement in response to the computer apparatus determining that the second computer arrangement has a trusted device.

### FIELD OF INVENTION

The present invention relates to an apparatus for and method of remote working.

### BACKGROUND ART

As communication technologies have improved there has been an increased need for workers to be able to work ‘anywhere, any time’. Additionally, as electronic equipment has become more sophisticated there has been a move towards workers travelling ‘light,’ where instead of a worker having to carry a laptop, and possibly a portable printer, a worker would ideally only have to carry a single lightweight device, such as a mobile phone or personal digital assistant (PDA).

However, as technology has progressed to allow portable lightweight devices to include considerable computational abilities, lightweight devices are inherently difficult to use, as by necessity they must have small keypads and displays.

Therefore, while a small portable device can provide sufficient computational power to allow a worker to work ‘anywhere, any time’ the small portable device does not provide comparable quality of information rendering, such as information presentation, printing, sound output, holographic output, and comparable ease of input and interaction, such as keyboard, pointing devices, voice activation, that a worker would expect at his/her ‘home office.’

One solution to this problem is to provide at remote locations personal computers that have sophisticated output, input and processing capabilities that a remote user could use to access their ‘home office’ over an electronic network.

Typically, however, the remote user requires that any information accessed by the remote user remain confidential. However, a non-secure communication link established between the remote location and the ‘home office’ could allow third parties to intercept and read any transmitted data. Additionally, an unknown computer accessed by a remote user could copy or store confidential information. For example, the remote computer could be infected by the Trojan virus, such that while the user is logged on user information could be copied and redirected to a malicious unauthorized party, or the computer could be infected with malicious software that transmit copies of all inputs to a malicious unauthorized party, who then can use user name and password input to masquerade as the authentic user. Additionally a remote computer could incorporate spying devices, for example a keystroke spying hardware device can be easily attached to the keyboard and capture information about user types, including password secret and confidential messages. Even if the remote computer does not include rogue software, confidential information can get left in the computer in cache or in temporary files that may not be removed after the remote user has logged off.

### SUMMARY OF THE INVENTION

In accordance with a first aspect of the present invention a computer system comprises a computer apparatus arranged to provide to a first computer arrangement a request to provide data to a second computer arrangement in response to a determination by the computer apparatus that the second computer arrangement incorporates a trusted device having cryptographic functionality to allow secure transmission of data from the first computer arrangement to the second computer arrangement.

In accordance with a second aspect of the present invention a computer system comprises a computer apparatus arranged to provide to a first computer arrangement a request to provide data to a second computer arrangement in response to a determination by the computer apparatus that the second computer arrangement incorporates a trusted device.

Preferably the trusted device incorporates a private key.

Preferably the computer apparatus provides an address associated with the second computer arrangement to the first computer arrangement. The address preferably is of the trusted device. Suitably, the trusted device provides an address of the trusted device to the computer apparatus.

Preferably the first computer system encrypts the data with a public key associated with the trusted device. The computer apparatus preferably provides the public key associated with the trusted device to the first computer arrangement. Preferably, the trusted device is tamper resistant.

The second computer arrangement preferably has an output device, e.g., a display, for outputting information derived from the data and a processor that forms part of the trusted device for processing the data.

In accordance with a third aspect of the present invention a computer apparatus comprises a processor arranged to generate a request for a first computer system to provide data to a second computer system in response to a determination by the processor that the second computer system incorporates a trusted device.

The computer apparatus preferably comprises a transmitter for providing the request to the first computer system. Preferably the transmitter provides an address associated with the second computer system and a public key associated with the trusted device to the first computer system. Preferably the address is of the trusted device of the second computer system.

### BRIEF DESCRIPTION OF THE DRAWING

For a better understanding of the present invention and to understand how the same is brought into effect reference is now made, by way of example only, to the accompanying drawings, in which:

FIG. 1 is a block diagram of a system in accordance with an embodiment of the present invention;

FIG. 2 is a block diagram of a motherboard including a trusted device, wherein the motherboard is included in a computer apparatus of FIG. 1;

FIG. 3 is a block diagram of the trusted device in more detail;

FIG. 4 is a flow diagram of control operations, including operations stored by a memory of a computer arrangement of FIG. 1, for causing a processor of the computer arrangement to acquire an integrity metric of the computing apparatus;

FIG. 5 is a flow diagram of control operations, including operations stored by a memory of a computer arrangement of FIG. 1, for causing a processor of the computer arrangement to establish communications between a trusted computing platform and a mobile device;

FIG. 6 is a block diagram of a system in accordance with another embodiment of the present invention;

FIG. 7 is a block diagram of a system in accordance with a further embodiment of the present invention.

### DETAILED DESCRIPTION OF THE DRAWING

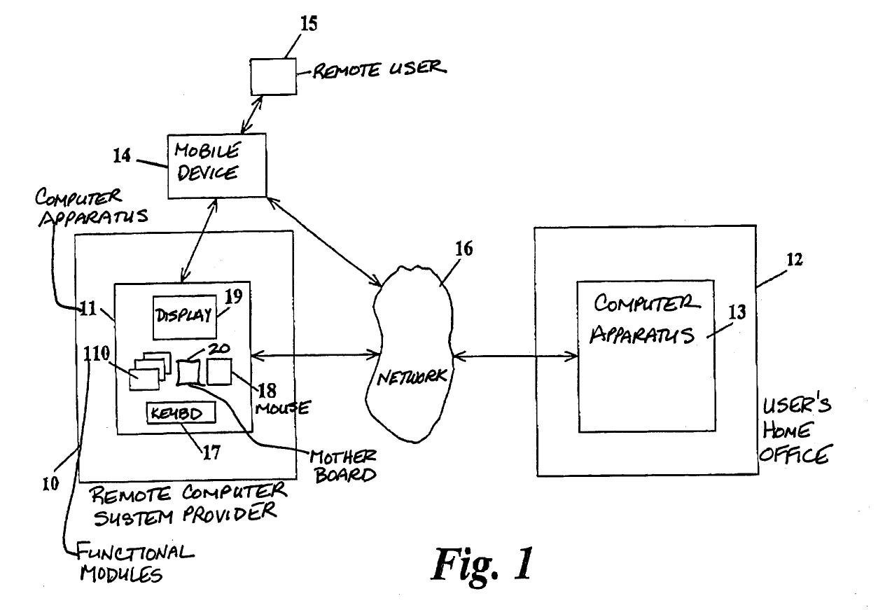

FIG. 1 is a block diagram of a system including (1) a remote computer system provider 10 having a first computer apparatus (i.e. computer platform) 11 including mother board 20, (2) a remote user's ‘home office’ 12 having a second computer apparatus 13, and (3) a mobile device 14 associated with a remote user 15. The second computer apparatus 13 within the remote user's ‘home office’ 12 contains data associated with the user 15. The computer apparatuses 11 and 13 as well as mobile device 14 are coupled to each other via a network 16, for example the Internet, thereby allowing a communication link to be established between the computer apparatuses 11 and 13 and mobile device 14; however, any suitable means for establishing a communication link can be used. The remote user 15 and associated mobile device 14 are located relatively close to the first computer apparatus 11. Additionally, or alternatively, the mobile device 14 is arranged to communicate directly with the first computer apparatus 11, for example via a dedicated cable or via wireless communication link.

To allow the remote user 15 to interact with the first computer apparatus 11 the first computer apparatus 11 typically includes several functional elements, namely a keyboard 17, mouse 18 and visual display unit (VDU) 19, which provide the physical ‘user interface’ of the platform. Computer apparatus 11 includes a plurality of modules 110. Modules 110 are additional functional elements of computer apparatus 11 which are appropriate to computer apparatus 11. The functional significance of such modules 110 is not relevant to the present invention and is not discussed further herein.

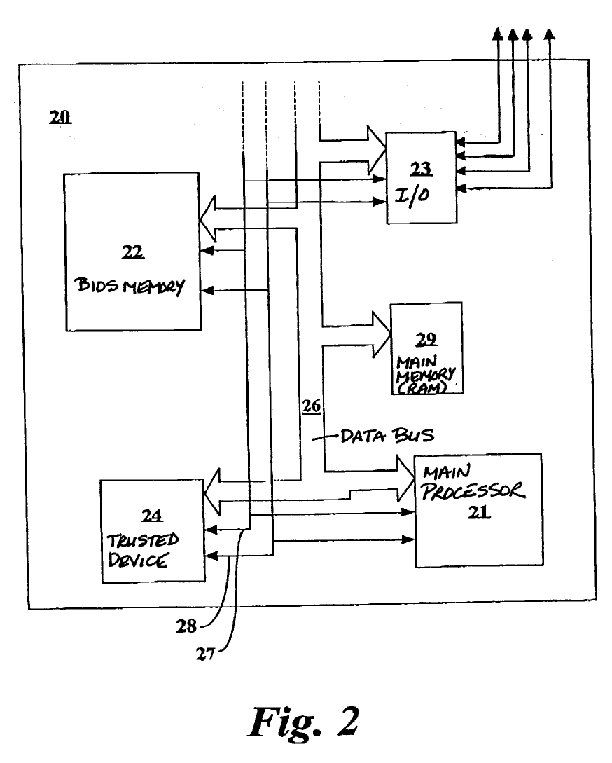

As illustrated in FIG. 2, the motherboard 20 of the first computer apparatus 11 includes (among other standard components) a main processor 21, main memory 29, a trusted device 24, a data bus 26 and respective control lines 27 and address lines 28, binary input/output system (BIOS) memory 22 including the BIOS program for the main processor 21 and an Input/Output (IO) device 23, which couples the computer apparatus 11 to the network 16 and the mobile device 14. The main memory 29 is typically a random access memory (RAM).

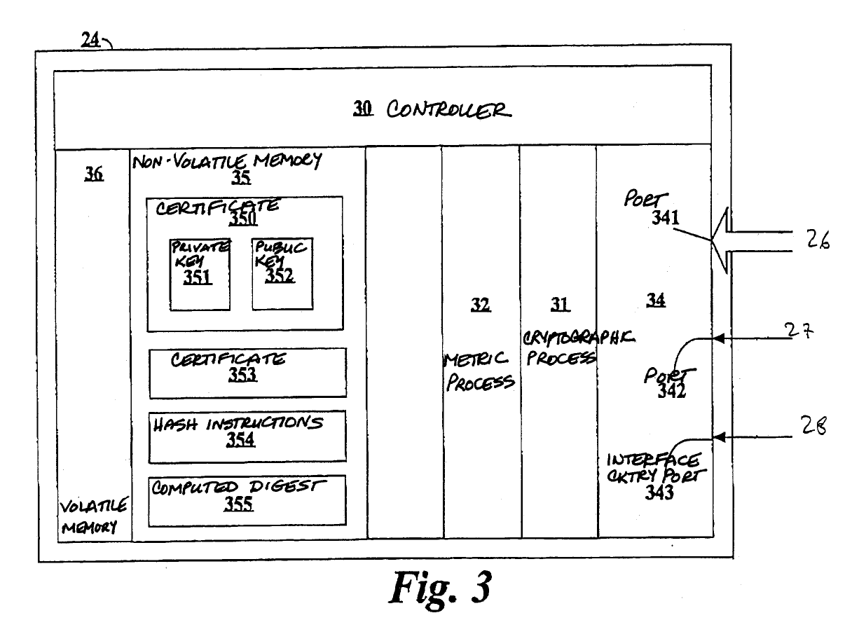

Although, the preferred embodiment of trusted device 24 (described in connection with FIG. 3) is a single, discrete component, it is envisaged that the functions of the trusted device 24 can be split into multiple devices on the motherboard 20, or even integrated into one or more of the existing standard devices of the computer apparatus 11. For example, it is feasible to integrate one or more of the functions of the trusted device 24 into the main processor 21 itself, provided that the functions of device 24 and communications with device 24 cannot be subverted. This, however, would probably require separate leads on the processor 21 for sole use by the trusted functions of device 24. Additionally, or alternatively, although in the present embodiment the trusted device 24 is a hardware device that is adapted for integration into the motherboard 20, it is understood that trusted device 24 can be a ‘removable’ device, such as a dongle, which could be attached to the computer apparatus 11, as required. Whether the trusted device is integrated or removable is a matter of design choice. However, if trusted device 24 is separable, a mechanism for providing logical binding between the trusted device 24 and the computer apparatus 11 should be included.

The trusted device 24, as illustrated in FIG. 3, comprises: (I) a controller 30, programmed to control (1) the overall operation of the trusted device 24, and (2) interact with (a) the other functions on the trusted device 24 and (b) other devices on the motherboard 20; (II) a metric process 31 for acquiring an integrity metric for the first computer apparatus 11; (III) a cryptographic process 32 for signing and encrypting or decrypting specified data with a private key (as described below); and (IV) interface circuitry 34 having appropriate ports (341, 342 and 343) for connecting the trusted device 24 respectively to the data bus 26, control lines 27 and address lines 28 of the motherboard 20. Each of the blocks in the trusted device 24 has access (typically via the controller 30) to appropriate volatile memory areas 36 and/or non-volatile memory areas 35 of the trusted device 24. Additionally, the trusted device 24 is arranged (as stated above), in a known manner, to be tamper resistant.

For reasons of performance, the trusted device 24 can be implemented as an application specific integrated circuit (ASIC). However, for flexibility, the trusted device 24 is preferably an appropriately programmed micro-controller. Both ASICs and micro-controllers are well known in the art of microelectronics and are not considered herein in any further detail.

The non-volatile memory 35 of the trusted device 24 stores a certificate 350 for the trusted device 24 and a certificate 353 for a trusted third party. The certificate 350 contains at least a public key 351 and private key 352 of the trusted device 24 and an authenticated value of the platform integrity metric (not shown) generated by the trusted third party. Prior to the certificate 350 being stored in the trusted device 24 the certificate 350 is signed by the trusted third party using the private key of the trusted third party. The certificate 353 of the trusted third party includes the public key (not shown) of the trusted third party.

To allow the trusted device 24 to determine if the computer apparatus 11 is operating in a trusted manner on system reset or initiation, the trusted device 24 performs a secure boot process to ensure that the operating system of the platform 11 (including the system clock and the display on the monitor) is running properly and in a secure manner. During the secure boot process, the trusted device 24 acquires an integrity metric of the computing platform 11 (as described below).

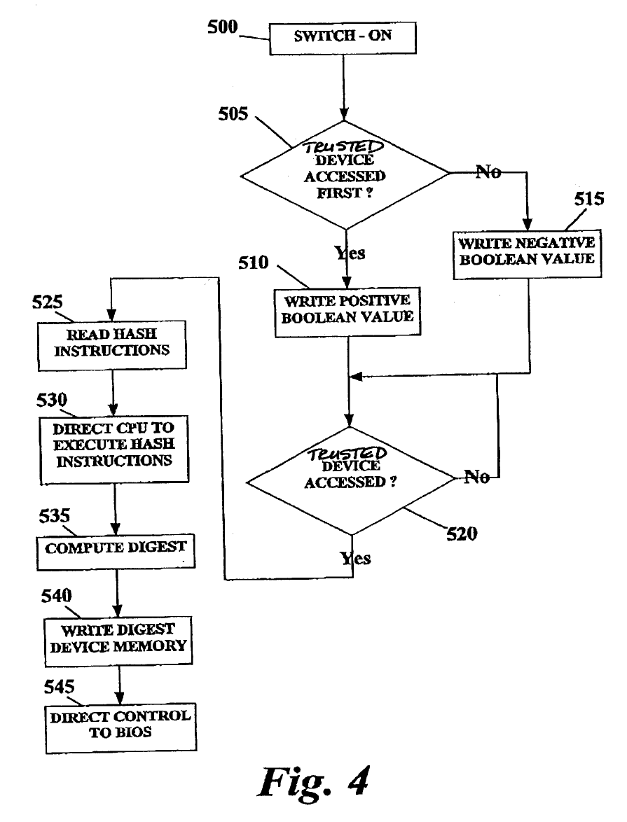

FIG. 4 is a flow diagram of a program that metric process 31 stores to measure the integrity metric. In step 500, at switch-on, process 31 monitors the activity of the main processor 21 on the data, control and address lines 26, 27 and 28. In step 505, process 31 determines if the trusted device 24 is the first memory accessed. If so, process 31 advances to step 510, during which process 31 writes to volatile memory 36 a Boolean value which indicates that the trusted device 24 was the first memory accessed. Otherwise, in step 515, process 31 writes to memory 36 a negative Boolean value which indicates that the trusted device 24 was not the first memory accessed and that the platform comprising computer apparatus 11 cannot be trusted.

If the trusted device 24 is not the first memory accessed, there is a chance that the trusted device 24 will not be accessed at all. This would be the case, for example, if the main processor 21 were manipulated to run the program that BIOS memory 22 stores before the trusted device was accessed. Under these circumstances, the platform comprising computer apparatus 11 would operate, but would be unable to verify its integrity on demand, since the integrity metric would not be available. Further, if the trusted device 24 were accessed after the program that BIOS memory 22 stores had been accessed, the Boolean value would indicate lack of integrity of the platform.

In step 520, process 31 determines if the trusted device 24 has been accessed as a memory by the main processor 21. If the determination of step 520 is negative, step 520 is continuously repeated until the determination is positive. Then process 31 causes main processor 21 to read stored native hash instructions 354 from the measurement process 31 in step 525. The hash instructions 354 are stored in non-volatile memory 35 in trusted device 24. The hash instructions 354 are passed for processing by the main processor 21 over the data bus 26. Then process 31 advances to step 530, during which main processor 21 executes the hash instructions 354 and uses them, in step 535, to compute a digest of the BIOS memory 22, by reading the contents of the BIOS memory 22 and processing those contents according to the hash program. Process 31 then advances to step 540, to command the main processor 21 to write the computed digest 355 to the appropriate non-volatile memory location 35 in the trusted device 24. Then, the metric process 31, in step 545, calls the BIOS program in the BIOS memory 22, and execution continues in a conventional manner.

There are a number of different ways the integrity metric can be calculated, depending upon the scope of the trust required. The measurement of the integrity of the BIOS program provides a fundamental check on the integrity of the underlying processing environment of the platform comprising computer apparatus 11. The integrity metric is of such a form as to enable reasoning about the validity of the boot process; the value of the integrity metric can be used to verify whether the platform booted up using the correct BIOS. Optionally, individual functional blocks within the BIOS can have their own digest values, with an ensemble BIOS digest being a digest of these individual digests. This enables a policy to state which parts of BIOS operation are critical for an intended purpose, and which are irrelevant (in which case the individual digests must be stored in such a manner that validity of operation under the policy can be established).

Other integrity checks can involve establishing that various other devices, components or apparatus attached to the platform comprising computer apparatus 11 are present and in correct working order. If the trusted device 24 is a separable component, some such interaction is desirable to provide an appropriate logical binding between the trusted device 24 and computer apparatus 11. Also, although in the present embodiment the trusted device 24 utilizes data bus 26 as its main means of communication with other parts of computer apparatus 11, it would be feasible, although not so convenient, to provide alternative communications paths, such as hard-wired paths or optical paths.

A remote user wishing to use computer apparatus 11 can verify the integrity of computer apparatus 11 by comparing the measured integrity metric 355 stored in memory 35 with an authentic integrity metric. If there is a match between the measured and authentic integrity metrics, the user can be confident that the platform 11 has not been subverted.

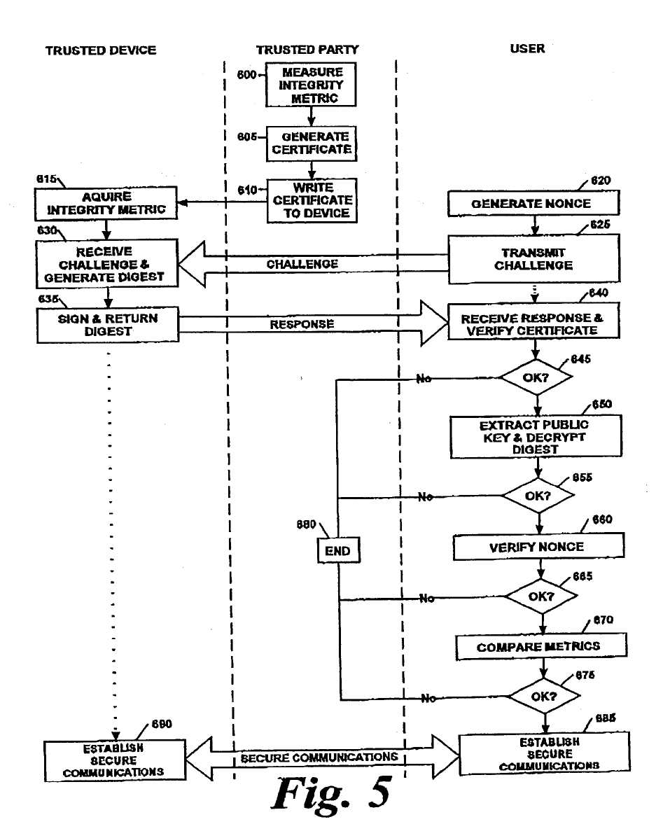

FIG. 5 is a flow diagram of one example of actions taken by a trusted third party (not shown), who wants to verify the integrity of the trusted platform comprising computer apparatus 11. FIG. 5 also indicates the steps taken by the trusted device 24 and the remote user 15 as a result of the third party integrity verification operations. At the first instance, a trusted third party, who vouches for trusted platforms, e.g., computer apparatus 11, sends a signal via a communication link to input/output device 23. Device 23 responds to the signal by addressing memory 22 to determine the type of platform incorporated in computer apparatus 11. Memory 22 sends a signal indicative of the type of platform incorporated in computer apparatus 11 back to input/output device 23, which couples the signal indicative of the type of platform incorporated in computer apparatus 11 back to the trusted third party. The trusted third party then decides whether or not to vouch for computer apparatus 11. If all is well, in step 600, the trusted third party sends a second signal to input/output device 23. Input/output device 23 routes the second signal to trusted device 24 to measure the value of the integrity metric of the platform comprising computer apparatus 11. Trusted device 24 then sends the value of the integrity metric back to input/output device 23 which couples a signal indicative of the metric to the trusted third party. Then, the trusted third party generates a certificate, in step 605, for the platform comprising computer apparatus 11. The trusted third party generates the certificate by appending the public key of the trusted device 24 to the measured integrity metric, and signing the string with the private key of the trusted third party.

The trusted device 24 can subsequently prove its identity by using its private key to process some input data received from the user and produce output data, such that the input/output pair is statistically impossible to produce without knowledge of the private key. Hence, knowledge of the private key forms the basis of identity in this case.

In step 610, the trusted third party sends the certificate to trusted device 24 via the communication link and input/output device 23. During step 610, the trusted device 24 is initialized by writing the certificate 350 into the appropriate non-volatile memory locations 35 of the trusted device 24. This is done, preferably, by secure communication with the trusted device 24 after installation of device 24 in the motherboard 20. The secure communication is supported by a ‘master key’, known only to the trusted person. The master key is written to the trusted device 24 during manufacture, and enables the writing of data to the trusted device 24; writing of data to the trusted device 24 without knowledge of the master key is not possible.

At some later point (in step 615) during operation of the platform comprising computer apparatus 11, for example when computer apparatus 11 is switched on or reset, the trusted device 24 measures and stores the integrity metric 355 of the platform (as described above).

When remote user 15 initiates (during step 620) communication, via the mobile device 14, with the platform comprising computer apparatus 11, the user creates a nonce (i.e., a parameter that varies with time), such as a random number. During step 625, user 15 challenges the trusted device 24. The operating system of the platform comprising computer apparatus 11, or an appropriate software application of the platform, is arranged at installation to recognize the challenge and pass it to the trusted device 24, typically via a BIOS-type call, in an appropriate fashion. The nonce protects the user from deception caused by replay of old but genuine signatures (called a ‘replay attack’) by untrustworthy platforms. The process of providing a nonce and verifying the response is an example of the well-known ‘challenge/response’ process.

In step 630, input/output device 23 routes the challenge to the trusted device 24. During step 630, trusted device 24 receives the challenge and creates an appropriate response, typically a digest of the measured integrity metric 355 and the nonce. Then, in step 635, controller 30 of the trusted device 24 causes the trusted device to sign the digest, using its private key 352, and return the signed digest via input/output device 23 and the link between computer apparatus 11 and mobile device 14 to the mobile device 14; the signed digest is accompanied by the certificate 350.

In step 640, the mobile device 14 receives the challenge response and verifies the certificate 350 using the well-known public key of the trusted third party. The mobile device 14 then, in step 650, extracts the public key 351 of trusted device 24 from the certificate 350 and uses the public key to decrypt the signed digest from the challenge response. Then, in step 660, the mobile device 14 verifies the nonce inside the challenge response. Next, during step 670, the mobile device 14 compares the computed integrity metric, which mobile device 14 extracts from the challenge response, with the proper platform integrity metric, which mobile device 14 extracts from the certificate. Steps 640, 650, 660 and 670 are followed by verification steps 645, 655, 665 and 675, respectively. If any of verification steps 645, 655, 665 or 675 fails, the user 15 cannot be certain that the platform comprising computer apparatus 11 is operating in a trusted manner.

During the challenge process the computer apparatus 11 can also provide information to the mobile device 14, such as a network address for the computer apparatus 11 and/or the trusted device 24 and associated functionality of the computer apparatus 11.

Assuming all is well, in steps 685 and 690, and the remote user 15 is satisfied that the computer apparatus 11 is operating in a trusted manner, the mobile device 14 passes the public key 351 of trusted device 24 and the network address associated to the computer apparatus 11 to the remote user's ‘home office’ 12, to enable the ‘home office’ computer apparatus 13 to communicate securely with the remote computer apparatus 11.

To ensure that the ‘home office’ computer apparatus 13 can trust that the mobile device 14 belongs to the user the mobile device 14 authenticates itself to the ‘home office’ computer apparatus 13. This authentication process could, for example, be based on the same process as described above for the authenticating of platform 11, where the mobile device 14 includes a trusted device (not shown).

The ‘home office’ 12 could be the home system of remote user 15, such as the user's own machine, or the user's office central server. The ‘home office’ can also be a computing utility provider that is contracted to provide the necessary processing power for the remote user.

In addition, information regarding the features of the computer apparatus 11 that was provided to the mobile device 14, such as the resolution of the display, the type of display, the capabilities and so forth is typically passed to the ‘home office’ 12.

The remote user 15 then instructs the ‘home office’ computer apparatus 13, via the mobile device 14, to perform the required processing of data, and asks for the output to be securely rendered at the computer apparatus 11 using the information provided by the mobile device 14 (e.g. the trusted device's public key and network address of trusted device 24). The mobile device 14 can communicate with the ‘home office’ 12 via the network 16; alternatively, the mobile device 14 can communicate with the ‘home office’ 12 via a wireless medium (not shown). The information output request by the mobile device 14 is transmitted by the ‘home office’ 12, via the network 16, in encrypted form using the public key 351 of trusted device 24, thereby allowing the remote user 15 to access the information on the remote computer apparatus 11 using the computer apparatus display 19 to view the data.

Once a communication link has been established between the ‘home office’ 12 and the computer apparatus 11, all subsequent information exchanged is encrypted so that the information remains confidential between the ‘home office’ 12 and the computer apparatus 11. Additionally, once the link has been established the remote user 15 can interact with any processes being completed in the ‘home office’ 12 via the computer apparatus interface, for example the keyboard 17 and mouse 18.

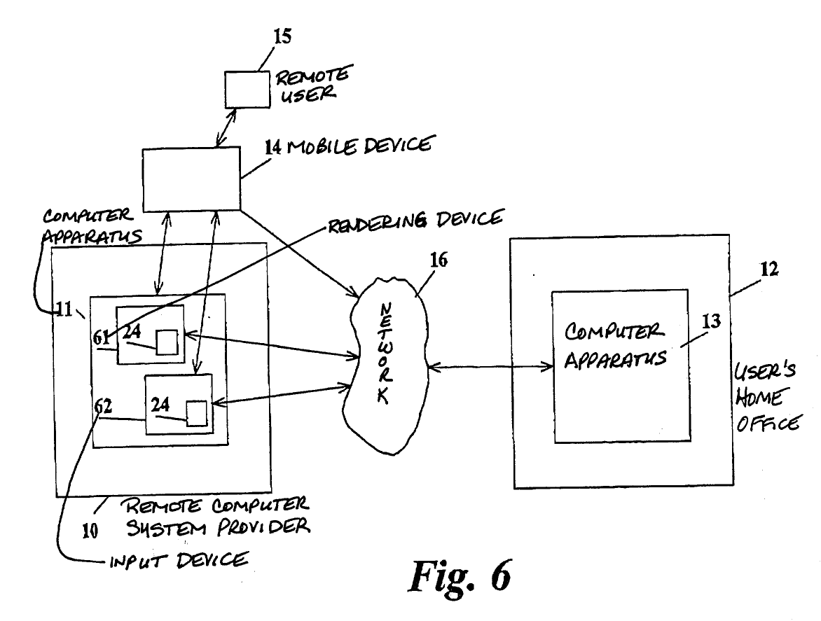

FIG. 6 is a block diagram of an alternative embodiment in which computer apparatus modules, for example a rendering device 61 and input device 62, have individual trusted devices 24, as described above. In this embodiment the mobile device 14 communicates directly with the trusted devices 24 and if remote user 15 determines, using the mobile device 14, that the modules 61, 62 operate in a trusted manner, similar to as describe above, the mobile device 14 supplies trusted device information to the ‘home office’ 12, along with a request for data, to allow the ‘home office’ 12 to establish a secure communication link with the modules 61, 62 using the public key 351 of trusted device 24 to encrypt data for the respective trusted module.

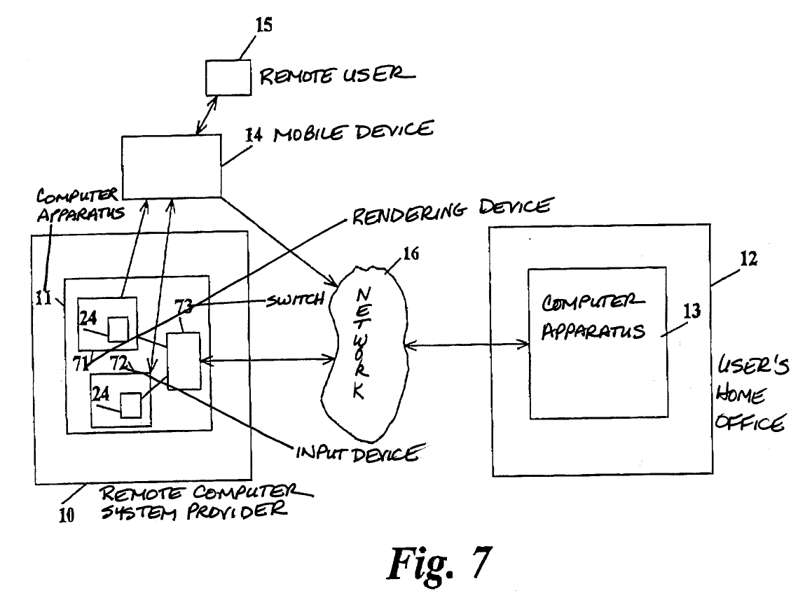

FIG. 7 is a block diagram of a further embodiment in which computer apparatus modules, for example rendering device 71 and input device 72, each have an individual trusted device 24. The embodiment of FIG. 7 differs from that of FIG. 6, because the FIG. 7 embodiment does not provide individual network addresses for the respective trusted modules 71, 72. Instead, in the FIG. 7 embodiment, the mobile device 14 provides a single network address to the ‘home office’ 12. The single network address corresponds to a switch 73 associated with the computer apparatus 11. The switch 73, on receiving information from the ‘home office’ 12 makes a determination as to which trusted module 71, 72 to forward the received information.

Thus, the present document describes a remote working environment in which a worker (i.e. remote user) uses a computing system remotely located from the worker's ‘home office’ computing system to interact with the worker's ‘home office’ to allow presentation of data from the ‘home office’ computing system on the remote computing system in a trusted manner.

In particular a small portable computing device (i.e. mobile device) belonging to a remote user is arranged to initiate a communication link between the remote users ‘home office’ computing system and a computer system remotely located from the remote users ‘home office’ computing system. The remotely located computer system is conveniently located to the remote user and incorporates a trusted device to provide the required trust.

A third party, trusted by the remote user, vouches (1) for the integrity of the trusted device, and (2) that the trusted device will maintain confidentiality of the remote user's data. The trusted third party can be contracted to provide, i.e., supply, the trusted device to the remote computer system provider or, alternatively, to validate a trusted device provided by the remote computer system provider.

The trusted device uses cryptographic processes but does not necessarily provide an external interface to those cryptographic processes. The trusted device is preferably tamperproof, to protect secrets by making them inaccessible to other computer platform functions and provide an environment that is substantially immune to unauthorized modification. Since tamper-proofing is impossible, the best approximation is a trusted device that is tamper-resistant (which includes tamper-detecting devices). The trusted device, therefore, preferably includes one physical component that is tamper-resistant.

Techniques relevant to tamper-resistance are well known to those skilled in the art of security. These techniques include methods of resisting tampering (such as appropriate encapsulation of the trusted device), methods of detecting tampering (such as detection of out of specification voltages, X-rays, or loss of physical integrity in the trusted device casing), and methods of eliminating data when tampering is detected.

The trusted device is preferably a physical device because it must be difficult to forge. It is most preferably tamper-resistant because it must be hard to counterfeit. It typically has an engine capable of using cryptographic processes.

When the remote user requires the rendering capabilities of the remote computer system to render data stored on the remote user's ‘home office’ computer system the user makes a determination as to the trustworthiness of the remote computer system before using the users mobile device to initiate a communication link between the remote user's ‘home office’ computing system and the remote computer system. For example, if the remote computer system is located in a company affiliated with the company for which the remote user works, the remote user might be satisfied that the remote computer system can be trusted and therefore the user will be primarily concerned with maintaining confidentiality of data while the data are being transmitted between the remote users ‘home office’ and the remote computer system. In this example a public key associated with the trusted device is obtained by the user's mobile device and forwarded by the mobile device to the user's ‘home office’, along with a network address associated with the trusted device, where the ‘home office’ recognizes and trusts the user's mobile device. The remote user's ‘home office’ can now use the trusted device's public key to connect to the remote computer system with the confidence that they are the only devices capable of receiving and sending information on behalf of the remote user. The user's mobile device can be arranged to be recognised and authenticated by the ‘home office’ computer system by any suitable means.

If, however, the remote computer system is in a non-trusted location the remote user will require some indication that the remote computer system can be trusted before initiating a secure communication link between the remote user's ‘home office’ computing system and the remote computer system.

The previously described embodiments are based on the use of a trusted device associated with a remote computer system to provide confidence to the remote user that the remote computer system operates in a trusted manner. However, as an alternative embodiment, trusted devices can be associated with specific computing modules within a computing system, for example a rendering device or input device, where the trusted device provides the necessary user functionality required by the user.

The purpose of the mobile device is to provide authentication of the remote computer system and to provide a public key associated with the remote computer system to the remote user's ‘home office’ to allow encryption of data transmitted from the ‘home office’ to the remote computer system.

Additionally, the mobile device can also be used as an indicator of a remote users' presence at the remote computer system.

1. Computer system comprising a computer apparatus, a first computer arrangement and second computer arrangement, the computer apparatus arranged to provide to the first computer arrangement a request to provide data to the second computer arrangement in response to a determination by the computer apparatus indicating the second computer arrangement incorporates a trusted device and prevent the data from being provided to the second computer in response to the determination indicating the second computer does not incorporate the trusted device.

2. Computer system according to claim 1, wherein the second computer arrangement includes the trusted device, the trusted device including cryptographic functionality to allow secure transmission of data from the first computer arrangement to the second computer arrangement.

3. Computer system according to claim 1, wherein the second computer arrangement includes the trusted device, the trusted device including a private key and associated public key.

4. Computer system according to claim 1, wherein the computer apparatus is arranged to provide an address associated with the second computer arrangement to the first computer arrangement.

5. Computer system according to claim 4, wherein the address is for the trusted device.

6. Computer system according to claim 1, wherein the second computer arrangement includes the trusted device, the trusted device being arranged to provide an address for the trusted device to the computer apparatus.

7. Computer system according to claim 1, wherein the first computer system is arranged to encrypt the data with a public key associated with the trusted device.

8. Computer system according to claim 7, wherein the computer apparatus is arranged to provide the public key associated with the trusted device to the first computer arrangement.

9. Computer system according to claim 1, wherein the trusted device is tamper resistant.

10. Computer system according to claim 1, wherein the second computer arrangement has an output device for outputting information derived from the data.

11. Computer system according to claim 10, wherein the output device includes a display.

12. Computer system according to claim 1, wherein the second computer arrangement has a processor for processing the data.

13. Computer system according to claim 12, wherein the processor forms part of the trusted device.

14. Computer system comprising a computer apparatus, a first computer arrangement and a second computer arrangement, the computer apparatus being arranged to provide to a first computer arrangement a request to provide data to a second computer arrangement in response to a determination by the computer apparatus that the second computer arrangement includes a trusted device having cryptographic functionality to allow secure transmission of the data from the first computer arrangement to the second computer arrangement and prevent the data from being provided to the second computer arrangement in response to the determination indicating the second computer arrangement does not incorporate the trusted device.

15. Computer apparatus comprising a processor arranged to generate a request for a first computer arrangement to provide data to a second computer arrangement in response to a determination by the processor that the second computer arrangement incorporates a trusted device.

16. Computer apparatus according to claim 15, further comprising a transmitter for providing the request to the first computer arrangement.

17. Computer apparatus according to claim 16, wherein the transmitter is arranged to provide an address associated with the second computer arrangement to the first computer arrangement.

18. Computer apparatus according to claim 17, wherein the address is for the trusted device of the second computer arrangement.

19. Computer apparatus according to claims 16, wherein the transmitter is arranged to provide a public key associated with the trusted device to the first computer arrangement.

20. Computer system comprising a mobile apparatus arranged to provide to a first computer arrangement a request to provide data to a second computer arrangement and an address associated with the second computer arrangement in response to a determination by the mobile apparatus that the second computer arrangement incorporates a trusted device, the trusted device including cryptographic functionality to allow secure transmission of data from the first computer arrangement to the second computer arrangement, the mobile apparatus and the second computer arrangement being arranged to interact locally to perform said determination.

21. Computer system according to claim 20, wherein the mobile apparatus is arranged to provide the public key associated with the trusted device to the first computer arrangement.

22. Computer system according to any claim 20, wherein the second computer arrangement has an output device for outputting information derived from the data.

23. Computer system according to claim 22, wherein the output device includes a display.

24. Computer system as claimed in claim 20 further including a wireless link or dedicated cable for providing the local interaction.

25. A method of operating a computer system comprising determining, by using a computer apparatus, if a second computer arrangement incorporates a trusted device and, if so, requesting a first computer arrangement to provide data to the second computer arrangement, by using the computer apparatus.

26. A method as claimed in claim 25 comprising providing an address associated with the second computer arrangement to the first computer arrangement.

27. A method as claimed in claim 25 wherein the first computer arrangement encrypts the data with a public key associated with the trusted device.

28. A method as claimed in claim 25, wherein the computer apparatus provides the public key associated with the trusted device to the first computer arrangement.

29. A method as claimed in claim 25 wherein the computer apparatus is a mobile device.

30. A computer apparatus for use with first and second computer arrangements, the computer apparatus including a processor and a memory, the processor and memory being arranged to cause the first computer arrangement to provide data to the second computer arrangement in response to a determination by the processor indicating the second computer arrangement incorporates a trusted device and prevent the data from being provided to the second computer in response to the determination indicating the second computer does not incorporate the trusted device.

31. A storage device for a computer apparatus for use with first and second computer arrangements, the memory storing signals for causing the computer apparatus to provide to the first computer arrangement a request to provide data to the second computer arrangement in response to a determination by the computer apparatus indicating the second computer arrangement incorporates a trusted device and prevent the data from being provided to the second computer in response to the determination indicating the second computer does not incorporate the trusted device.

32. A computer apparatus for use with first and second computer arrangements, the computer apparatus including a processor and a memory, the processor and memory being arranged to cause the first computer arrangement to provide data to the second computer arrangement in response to a determination by the processor that the second computer arrangement includes a trusted device having cryptographic functionality to allow secure transmission of the data from the first computer arrangement to the second computer arrangement and prevent the data from being provided to the second computer in response to the determination indicating the second computer does not incorporate the trusted device.

33. A storage device for a computer apparatus for use with first and second computer arrangements, to provide data to the second computer arrangement in response to a determination by the processor that the second computer arrangement includes a trusted device having cryptographic functionality to allow secure transmission of the data from the first computer arrangement to the second computer arrangement and prevent the data from being provided to the second computer in response to the determination indicating the second computer does not incorporate the trusted device.
